(19) United States
(12) Patent Application Publication
(10) Pub. No.: US 2003/0122738 A1
(43) Pub. Date: Jul. 3, 2003

(54) Method and apparatus for driving plasma display panel

(75) Inventor: Eun Cheol Lee, Kumi-shi (KR)

Correspondence Address: FLESHNER & KIM, LLP, P.O. Box 221200, Chantilly, VA, 20153-1200, US

(73) Assignee: LG Electronics Inc.

(21) Appl. No.: 10/328,138

(22) Filed: Dec. 26, 2002

(30) Foreign Application Priority Data
Dec. 28, 2001 (KR) P2001-86962

(51) Int. Cl. G09G 3/28

(52) U.S. Cl. 345/60

(57) ABSTRACT

It is disclosed that there are a method and an apparatus for driving a plasma display panel that is adaptive for realizing a high resolution as well as improving a brightness.

In a method and an apparatus of driving a plasma display panel according to the present invention, the plasma display panel has scan electrodes intersect data electrodes that overlap with barrier ribs periodically, wherein a scan pulse is simultaneously applied to at least two or more of the scan electrodes.

### BACKGROUND OF THE INVENTION

1. Field of the Invention

This invention relates to a plasma display panel, and more particularly to a method and an apparatus for driving a plasma display panel that is adaptive for realizing a high resolution as well as improving a brightness.

2. Description of the Related Art

Generally, a plasma display panel (PDP) allows an ultraviolet ray generated when an inactive gas such as He+Xe, Ne+Xe or He+Xe+Ne, etc. is discharged to radiate a phosphorus material, to thereby display a picture. Such a PDP is easy to be made into a thin-film and large-dimension type. Moreover, the PDP provides a very improved picture quality owing to a recent technical development. Recently, a three-electrode, alternating current (AC) surface-discharge type PDP capable of lowering a driving voltage with the aid of wall charges accumulated on a dielectric material has been developed and becomes available in the market.

Referring to FIG. 1, a conventional three-electrode AC surface-discharge PDP has n scan electrodes Y1 to Yn and n common sustain electrodes Z intersected with m data electrodes X1 to Xm with having a discharge space therebetween. The intersections are provided with m×n cells 1. Barrier ribs 2 for shutting off electrical and optical interference between the cells 1 being adjacent to each other in the horizontal direction are provided between adjacent data electrodes X1 to Xm.

The scan electrodes Y1 and Yn are sequentially supplied with a scan signal to select scan lines. The scan electrodes Y1 and Yn and the common sustain electrodes Z are alternately supplied with a sustain pulse to thereby cause a sustain discharge to the selected cells. The data electrodes X1 to Xm are supplied with a data pulse synchronized with the scan signal to select the cells 1.

Such a three-electrode AC surface-discharge PDP drives one frame, which is divided into various sub-fields having a different emission frequency, so as to realize gray levels of a picture. Each sub-field is again divided into a reset period (or initialization period) for initializing the full screen, an address period (or scan period) for selecting the scan line and selecting the cell from the selected scan line and a sustain period (or display period) for expressing gray levels depending on the discharge frequency. For instance, when it is intended to display a picture of 256 gray levels, a frame period equal to 1/60 second (i.e. 16.67 msec) is divided into 8 sub-fields SF1 to SF8 as shown in FIG. 2. Each of the 8 sub-field SF1 to SF8 is divided into a initialization period, a scan period and a display period. Herein, the initialization period and the address period of each sub-field are equal for each sub-field, whereas the display period is increased at a ratio of 2ⁿ (wherein n=0, 1, 2, 3, 4, 5, 6 and 7) at each sub-field.

FIG. 3 shows a driving waveform of the conventional three-electrode AC surface-discharge PDP.

Referring to FIG. 3, in the initialization period, a ramp-up waveform and a ramp-down waveform are simultaneously applied to all the scan electrodes Y. The ramp-up waveform causes a discharge within the cells at the full screen and hence wall charges are generated within the cells at the full screen. The ramp-down waveform causes a weak erasure discharge within the cells to erase unnecessarily excessive charges, of wall charge and space charges generated by a set-up discharge, thereby uniformly leaving wall charges required for an address discharge within the cells at the full screen.

In the address period, a negative scan pulse SCAN is sequentially applied to the scan electrodes Y and, at the same time, a positive data pulse DATA synchronized with the scan pulse SCAN is applied to the data electrodes X. While a voltage difference between the scan pulse SCAN and the data pulse DATA is added to the wall charges generated in the initialization period, an address discharge is generated within the cell supplied with the data pulse DATA.

On the other hand, during the period while the ramp-down waveform is applied and the address period, the common sustain electrode Z is supplied with a positive DC voltage Zdc.

During the sustain period, the sustain pulse SUS is alternately applied to the scan electrodes Y and the common sustain electrodes Z. Whenever the sustain pulse SUS is applied, in the cell selected by the address discharge, wall voltages within the cell are added to the voltage of the sustain pulse SUS to generate a sustain discharge in a surface discharge type between the scan electrode Y and the common sustain electrode Z. At the end point of time of the sustain period, there may be applied an erasure signal for erasing the sustain discharge.

By the way, the conventional PDP has difficulty in assuring enough sustain period in the event of high resolution accompanied with the increase of the number of lines and cells thereof or in the event of adding sub-fields to reduce a pseudo contour noise in a moving picture.

For instance, in a resolution of VGA (video graphics array) class, an address period needed in one sub-field is 1.44 ms; that is, 3 μs (a pulse width of the scan pulse needed in one line scan)×480=1.44 ms. The initialization period needed in each sub-field is around 300˜600 μs. Assuming that 8 sub-fields SF1 to SF8 are included within one frame period 16.67 ms as in FIG. 2, the total initialization period and address period needed within one frame period in a resolution of VGA class is (1.44 ms×8)+((0.3˜0.6 ms)×8)=13.92˜16.32 ms. In the resolution of VGA class, if 8 sub-fields are included, the sustain period within one frame period except for the initialization and address period is 16.67 ms (frame period)−(13.92˜16.32 ms)=0.35˜2.75 ms, such that it is no more than 2.09˜16.5% of one frame period. Accordingly, if 8 sub-fields are allocated within one frame period in the resolution of VGA class, the brightness is unavoidably low because of lack of the sustain period. Besides, if the number of sub-field is increased more, the sustain period cannot be allocated within one frame period.

If the resolution is increased to be of XGA (1024×768) class, an address period needed in one sub-field is 2.3 ms; that is, 3 μs (a pulse width of the scan pulse needed in one line scan)×768=2.3 ms. Also, the initialization period needed in each sub-field is around 300˜600 μs. In the resolution of XGA class, assuming that 8 sub-fields SF1 to SF8 are included, the total initialization period and address period within one frame period is (2.3 ms×8)+((0.3˜0.6 ms)×8)=20.8˜23.2 ms. In this case, the sustain period except for the initialization and address period is 16.67 ms (frame period)−(20.8˜23.2 ms)=−6.53˜−4.13 ms. Accordingly, if 8 sub-fields are allocated within one frame period in the resolution of XGA class, because a display period, i.e., the sustain period, cannot be allocated, it is not possible to display a picture.

### SUMMARY OF THE INVENTION

Accordingly, it is an object of the present invention to provide a method and an apparatus for driving a plasma display panel that is adaptive for realizing a high resolution as well as improving a brightness.

In order to achieve these and other objects of the invention, a method of driving a plasma display panel according to one aspect of the present invention, the plasma display panel has scan electrodes intersect data electrodes that overlap with barrier ribs periodically, wherein a scan pulse is simultaneously applied to at least two or more of the scan electrodes.

The scan pulses are applied to the plasma display panel, beginning from the top thereof, and then are shifted downward.

The scan pulses are applied to the plasma display panel, beginning from the bottom thereof, and then are shifted upward.

The scan pulses are applied to the plasma display panel, beginning from the top thereof, and then are shifted downward, and at the same time beginning from the bottom thereof, and then is shifted upward.

There are at least two or more sub-fields in which scan directions of the scan pulses are different from each other when shifted.

The method further includes a step of dividing data pulses synchronized with the scan pulses into odd-numbered lines and even-numbered lines and applying the data pulse to the data lines.

A driving apparatus of a plasma display panel according to another aspect of the present invention includes a plasma display panel having scan electrodes intersect data electrodes that are located under barrier ribs periodically; and a scan driver simultaneously applying a scan pulse to at least two or more of the scan electrodes.

Herein, the scan driver applies the scan pulses to the plasma display panel, beginning from the top thereof, and then are shifted downward.

Herein, the scan driver applies the scan pulses to the plasma display panel, beginning from the bottom thereof, and then are shifted upward.

Herein, the scan driver applies the scan pulses to the plasma display panel, beginning from the top thereof, and then are shifted downward, and at the same time beginning from the bottom thereof, and then is shifted upward.

Herein, the scan driver makes scan directions of the shifted scan pulses different in sub-fields that are different from one another.

The driving apparatus further includes a data driver dividing data pulses synchronized with the scan pulses into odd-numbered lines and even-numbered lines and applying the data pulse to the data lines.

Herein, the scan driver includes a switching device connected in parallel with at least two or more of the scan electrodes and applying the scan pulse to at least two or more of the scan electrodes at the same time.

Herein, the barrier ribs are a lattice type and are arranged in a delta pattern to be deviated from adjacent cells in a vertical direction.

Herein, the data electrodes include odd-numbered data electrodes exposed within the cell area of odd-numbered horizontal lines and located under the barrier ribs in even-numbered horizontal lines; and even-numbered data electrodes exposed within the cell area of even-numbered horizontal lines and located under the barrier ribs in odd-numbered horizontal lines.

Herein, the barrier ribs are a lattice type and are arranged in a delta pattern to be deviated from adjacent cells in a vertical direction every second line.

Herein, the data electrodes include odd-numbered data electrodes exposed within the cell area of i^{th} (provided that i is a natural number) and (i+1)^{th} horizontal lines, and located under the barrier ribs in (i+2)^{th} and (i+3)^{th} horizontal lines; and even-numbered data electrodes located under the barrier ribs in i^{th} and (i+1)^{th} horizontal lines, and exposed within the cell area of (i+2)^{th} and (i+3)^{th} horizontal lines.

The driving apparatus further includes a sustain electrode generating a sustain discharge, together with the scan electrode.

Herein, the scan electrode and the sustain electrode each include a metal bus electrode.

Herein, the lattice type barrier ribs include transversal barrier ribs and longitudinal barrier ribs, and the metal bus electrode overlaps with the transversal barrier ribs.

### BRIEF DESCRIPTION OF THE DRAWINGS

These and other objects of the invention will be apparent from the following detailed description of the embodiments of the present invention with reference to the accompanying drawings, in which:

FIG. 1 is a plane view showing an electrode arrangement of a conventional three-electrode AC surface-discharge plasma display panel;

FIG. 2 illustrates a configuration of one frame of a conventional plasma display panel;

FIG. 3 illustrates a driving waveform of the plasma display panel shown in FIG. 1;

FIG. 4 is a block diagram representing a plasma display panel and its driver according to the first embodiment of the present invention;

FIG. 5 is a brief diagram representing a scan driver IC of a scan driver and a scan electrode of a plasma display panel connected to an output terminal thereof;

FIG. 6 is a diagram briefly representing a unit switching device part of the scan driver IC shown in FIG. 5;

FIG. 7 is a brief diagram representing that a contact point of a scan driver and scan electrodes shown in FIG. 4 is located outside a plasma display panel;

FIG. 8 is a brief diagram representing that a contact point of a scan driver and scan electrodes shown in FIG. 4 is located inside a plasma display panel;

FIG. 9 is a block diagram representing a plasma display panel and its driver according to the second embodiment of the present invention;

FIG. 10 is a frame schematic representing a driving method of a plasma display panel according to the first embodiment of the present invention;

FIG. 11 is a frame schematic representing a driving method of a plasma display panel according to the second embodiment of the present invention;

FIG. 12 is a frame schematic representing a driving method of a plasma display panel according to the third embodiment of the present invention;

FIG. 13 is a frame schematic representing a driving method of a plasma display panel according to the fourth embodiment of the present invention;

FIG. 14 is a frame schematic representing a driving method of a plasma display panel according to the fifth embodiment of the present invention;

FIG. 15 illustrates a driving waveform for realizing a driving method of a plasma display panel according to the first embodiment of the present invention;

FIG. 16 illustrates a driving waveform for realizing a driving method of a plasma display panel according to the second embodiment of the present invention;

FIG. 17 illustrates a driving waveform for realizing a driving method of a plasma display panel according to the third embodiment of the present invention;

FIG. 18 is a block diagram representing a plasma display panel and its driver according to the second embodiment of the present invention;

FIG. 19 is a plane view briefly representing a scan driver IC of a scan driver and a scan electrode of a plasma display panel connected to an output terminal thereof shown in FIG. 18;

FIG. 20 is a diagram briefly representing a unit switching device part of the scan driver IC shown in FIG. 19; and

FIG. 21 is a block diagram representing a plasma display panel and its driver according to the fourth embodiment of the present invention.

FIG. 22 is a block diagram representing a plasma display panel according to the fifth embodiment of the present invention.

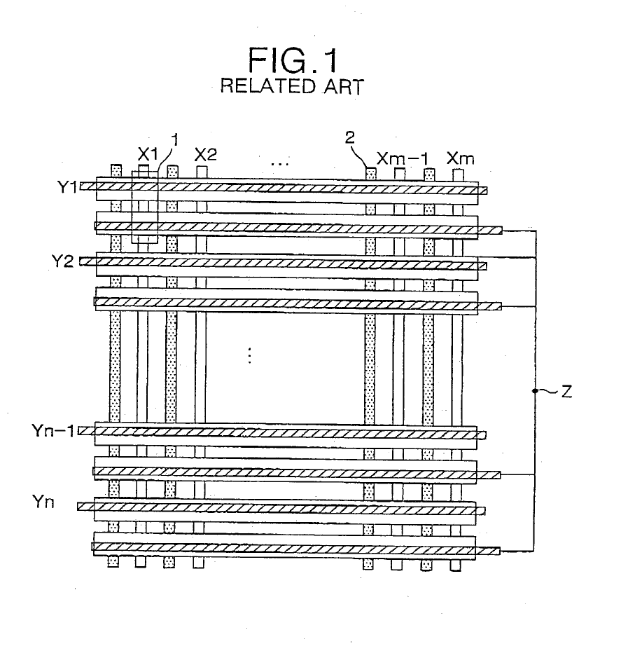

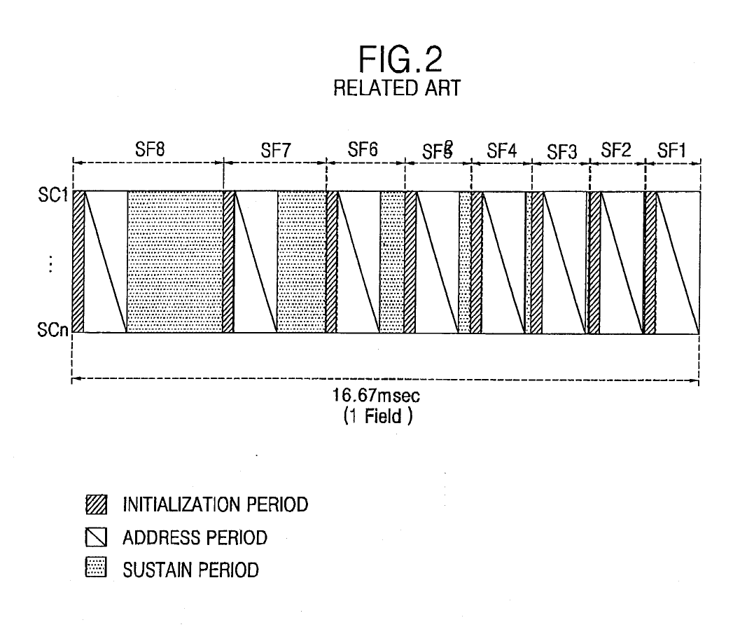

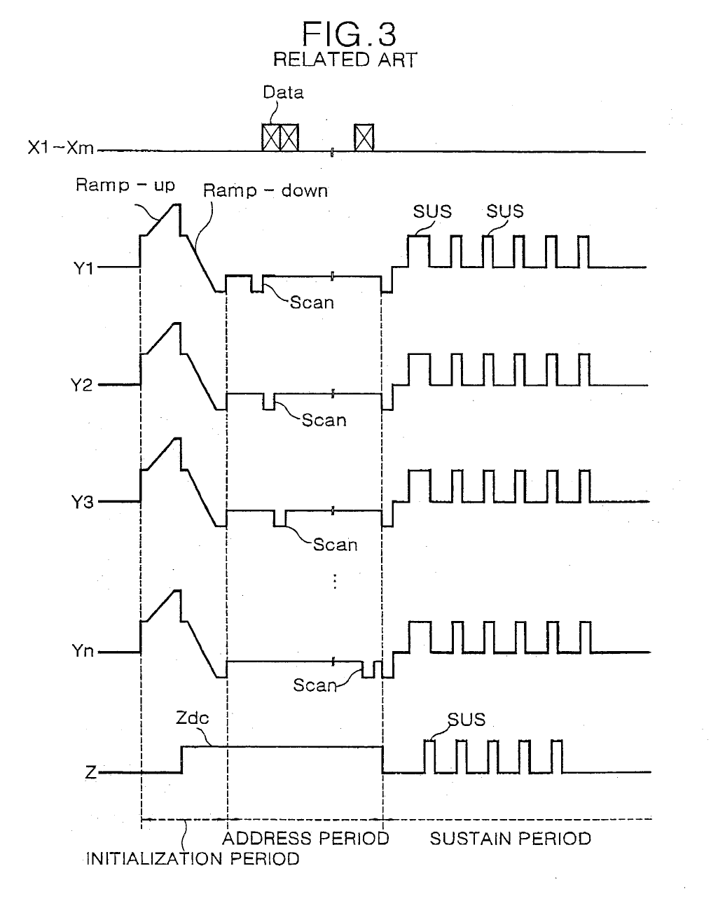

### DETAILED DESCRIPTION OF THE PREFERRED EMBODIMENT

Reference will now be made in detail to the preferred embodiments of the present invention, examples of which are illustrated in the accompanying drawings.

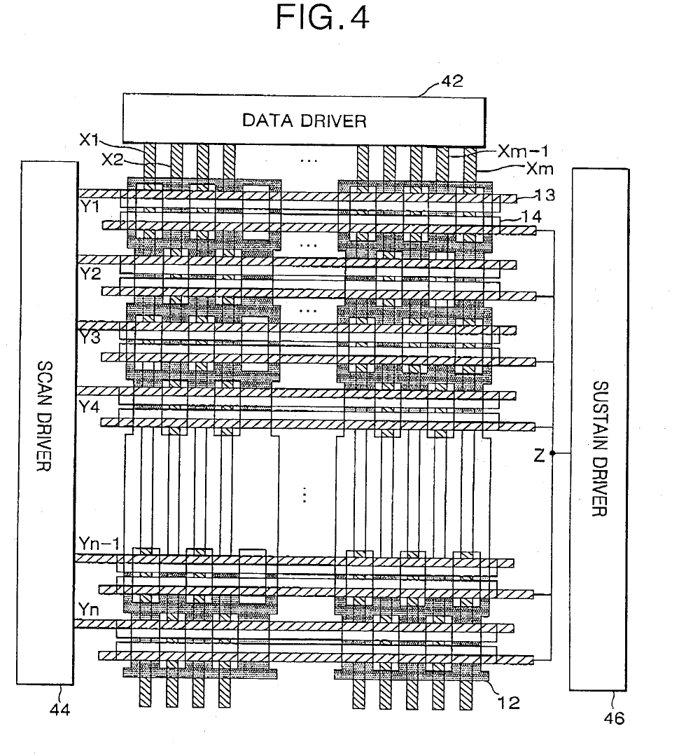

FIG. 4 illustrates a PDP and its driving apparatus according to the present invention.

Referring to FIG. 4, the PDP according to an embodiment of the present invention includes a lattice barrier ribs 12 arranged in a delta pattern to be deviated from adjacent cells by 1/2 cell pitch in a longitudinal direction; odd numbered data electrodes X1, X3, . . . , Xm−1 exposed within a cell area of an odd numbered horizontal line and located under the lattice barrier ribs 12 in an even numbered horizontal line; and even numbered data electrodes X2, X4, . . . , Xm exposed within a cell area of an even numbered horizontal line and located under the lattice barrier ribs 12 in an odd numbered horizontal line.

There are scan electrodes Y1 to Yn and common sustain electrodes Z formed on an upper glass substrate (not shown).

The scan electrodes Y1 to Yn and the common sustain electrode Z each include a transparent electrode 14 of indium-tin-oxide ITO and a metal bus electrode that is formed on the transparent electrode 14 for reducing a voltage drop caused by the transparent-electrode.

On the upper glass substrate, a dielectric layer and an MgO passivation film (not shown) are deposited to cover the scan electrodes Y1 to Yn and the common sustain electrode Z.

There is a dielectric thick film formed on a lower glass substrate that faces the upper glass substrate with a discharge space therebetween, the dielectric thick film covering data electrodes X1 to Xm.

On the dielectric thick film, the lattice barrier ribs 12 are formed by a screen print, a sputtering or a mold method etc. On the surface of the dielectric thick film and the lattice barrier ribs 12, there are a red fluorescent body of (Ygd) BO₃:Eu3+, a green fluorescent body of Zn₂SiO₄:Mn2+ and a blue fluorescent body of BaMgA110017:Eu2+ formed by the screen print etc.

After an upper plate and a lower plate of such a PDP are bonded together, it is made to exhaust the discharge space provided between the upper plate, the lower plate and the barrier ribs 12. Subsequently to the exhaust, there are inert gas mixture such as He+Xe, Ne+Xe, He+Xe+Ne etc. interposed into the discharge space.

The odd numbered data electrodes X1, X3, . . . , Xm−1 are exposed within the cell area of the odd numbered horizontal line and located under the lattice barrier ribs 12 in the even numbered horizontal line, not to be exposed in the horizontal line. The even numbered data electrodes X2, X4, . . . , Xm are exposed within the cell area of the even numbered horizontal line and located under the lattice barrier ribs 12 in the odd numbered horizontal line, not to be exposed in the horizontal line

Also, the driving apparatus of the PDP according to the embodiment of the present invention includes a data driver 42 for applying video data to the data electrodes X1 to Xm, a scan driver 44 for applying a scan signal and a sustain pulse to the scan electrodes Y1 to Yn, and a sustain driver 46 for applying a sustain pulse to the common sustain electrode Z.

The data driver 42 applies the data for selecting cells of the odd numbered horizontal line to the odd numbered data electrodes X1, X3, . . . , Xm−1, and at the same time, the data for selecting cells of the even numbered horizontal line to the even numbered data electrodes X2, X4, . . . , Xm. The data driver 42 can be installed on the upper side or the lower side of the panel.

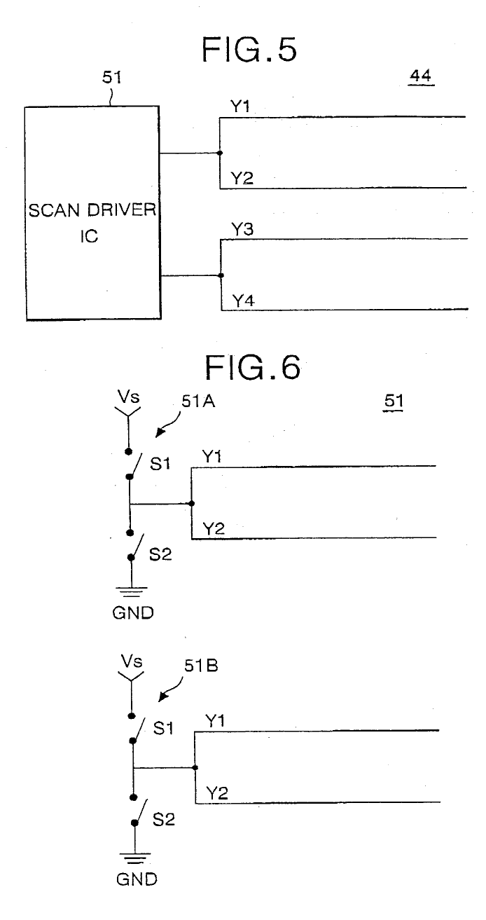

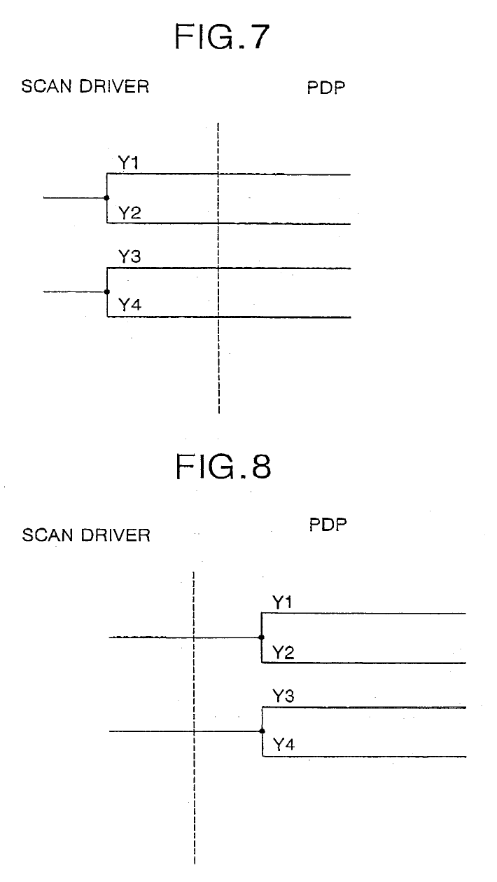

The scanning driver 44 applies the scan pulse to two scan electrodes simultaneously and shifts the scan pulse from top to bottom or from bottom to top with respect to n number of the scan electrodes Y1 to Yn. Also, the scan driver 44 selects the scan line, then applies the sustain pulse to the n number of scan electrodes Y1 to Yn. Each of a plurality of driver integrated circuit IC's 51 included in the scan driver 44 have it output terminal connected in parallel with two scan electrodes as in FIGS. 5 and 6 in order to select two scan lines with one scan pulse. Each output terminal of the scan driver IC 51 is connected to a push pull switch including a switch S1 that applies a sustain voltage Vs and a switch S2 that applies a ground voltage GND. Herein, a contact point between the two scan electrodes can be located inside the scan driver 44 or outside the panel as in FIG. 7, or can be located on the panel as in FIG. 8.

The sustain driver 46 and the scan driver 44 alternately applies the sustain pulse to the common sustain electrode Z.

In the scan driver 44 and the sustain driver 46, there can be installed an energy recovery circuit recovering reactive power from the PDP in use of LC resonant waveform and reusing it, though not shown here.

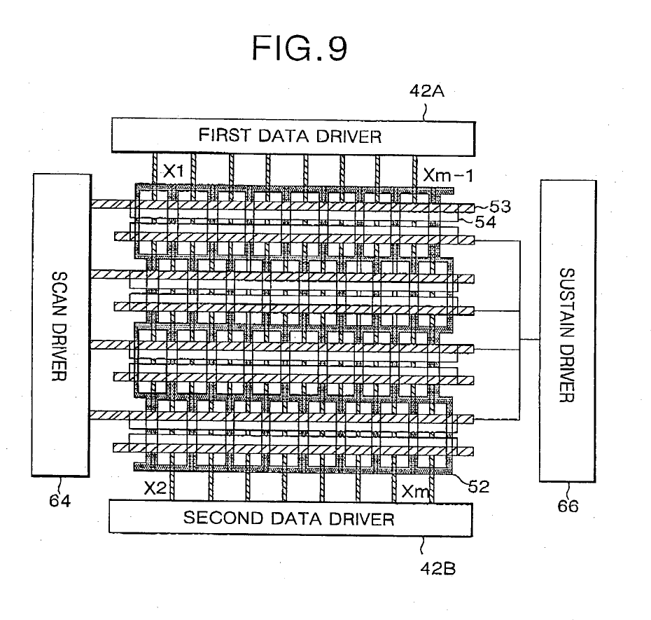

On the other hand, the data driver 42, as in FIG. 9, can be divided into a first data driver 42A driving the odd numbered data electrode X1, X3, . . . , Xm−1 and a second data driver 42B driving the even numbered data electrode X2, X4, . . . , Xm. The first data driver 42A is installed at an upper end of the panel and connected to the odd numbered data electrodes X1, X3, . . . , Xm−1, thereby applying odd numbered data to the odd numbered data electrodes X1, X3, . . . , Xm−1 simultaneously. The second data driver 42B is installed at a lower end of the panel and connected to the even numbered data electrodes X2, X4, . . . , Xm, thereby applying even numbered data to the even numbered data electrodes X2, X4, . . . , Xm.

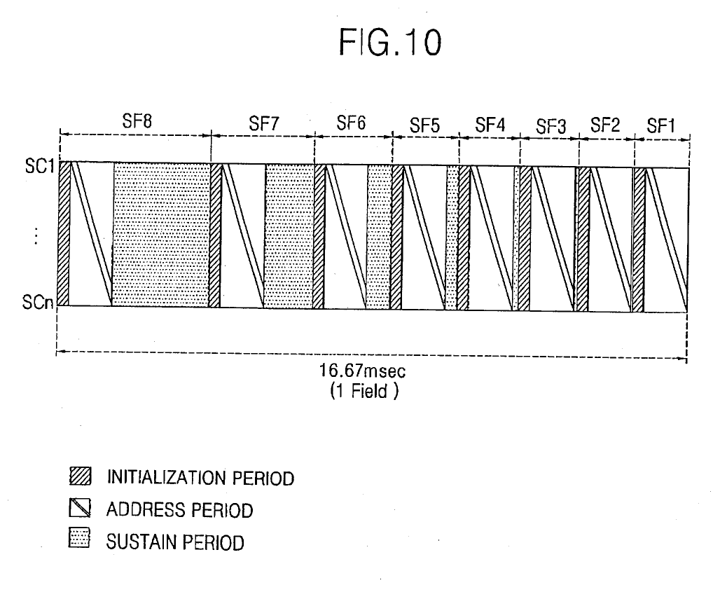

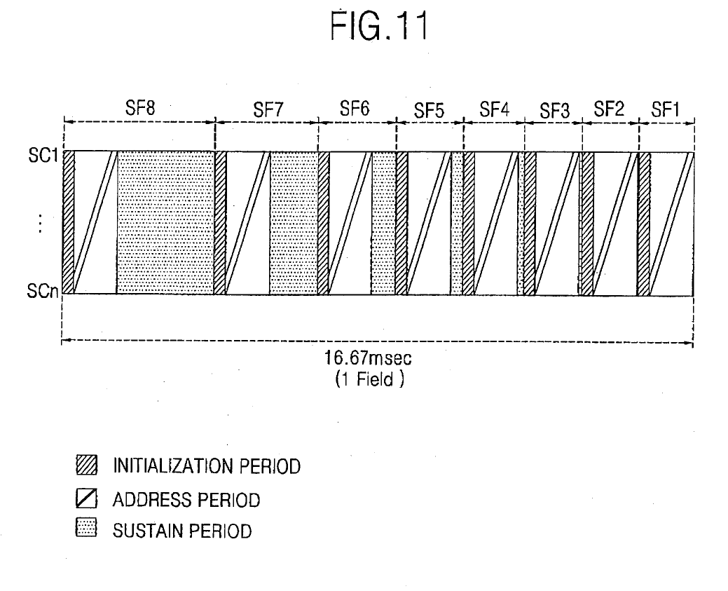

The driving apparatus of the PDP according to the present invention, as in FIGS. 10 to 14, simultaneously selects two scan lines every address period of each sub-field to reduce the address period into half as much as that of the prior art and the sustain period thereof can be sufficiently assured as much as the address period gets shortened. Furthermore, the driving apparatus of the PDP according to the present invention simultaneously selects two or more scan lines every address period of each sub-field to reduce the address period into half or less than that of the prior art. Herein, the scan line means the horizontal line selected by the scan pulse.

Referring to FIG. 10, in a driving method of the PDP according to the first embodiment of the present invention, two scan lines, i.e., fj^{th} (provided that fj represents odd numbers increasing in order of 1,3, . . . ,n−1) scan line SCFJ and (fj+1)^{th} scan line SCFJ+1, are scanned simultaneously. Also, in the driving method of the PDP according to the first embodiment of the present invention, scan is shifted in a forward sequential direction where it proceeds from top to bottom.

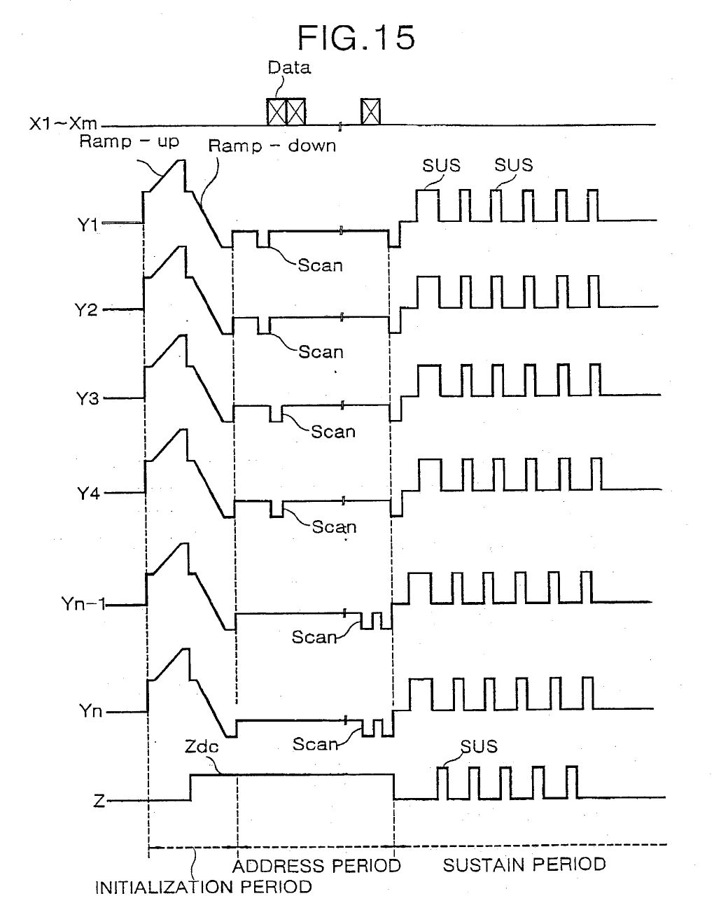

FIG. 15 illustrates a driving waveform for realizing a driving method shown in FIG. 10.

Referring to FIG. 15, all scan electrodes Y1 to Yn are simultaneously supplied with a ramp-up waveform and a ramp-down waveform during an initialization period. The ramp-up waveform causes a discharge within cells of a full screen, resulting wall charges generated within the cells of the full screen. The ramp-down waveform generates a weak erasure discharge within the cells to eliminated unnecessarily excessive charges among the wall charges and space charges generated by a setup discharge, thereby uniformly keeping the wall charge necessary for the address discharge within the cells of the full screen.

During the address period, a negative scan pulse SCAN is simultaneously applied to fj^{th} scan electrode Yfj and (fj+1)^{th} scan electrode Yfj+1. The scan pulse SCAN is shifted in a forward sequential direction where it proceeds from top to bottom. In other words, after the scan pulse SCAN is simultaneously applied to first and second scan electrodes Y1 and Y2, the scan pulse is shifted in the forward sequential direction, and then the scan pulse is simultaneously applied to (n−1)^{th} and n^{th} scan electrodes Yn−1 and Yn lastly. The data electrode X1 to Xm are supplied with a data pulse DATA synchronized with the scan pulse SCAN. When a voltage difference between the scan pulse SCAN and the data pulse DATA is added to the wall voltage generated in the initialization period, an address discharge is generated within the cell supplied with the data pulse DATA. At this moment, the even numbered data electrodes X2, X4, . . . , Xm and the odd numbered data electrodes Y1, Y3, . . . ,Yn−1 are overlapped having lattice barrier ribs 12 therebetween, so there is no discharge generated even though the data DATA are applied to the even numbered data electrodes X2, X4, . . . ,Xm. Because of this, the cells of the odd numbered horizontal line are selected by the discharge generated between the odd numbered data electrodes X1, X3, . . . , Xm−1 and the odd numbered scan electrodes Y1, Y3, . . . , Yn−1.

On the contrary, the odd numbered data electrodes X1, X3, . . . , Xm−1 and the even numbered scan electrodes Y2, Y4, . . . , Yn are overlapped having lattice barrier ribs 12 therebetween, so there is no discharge generated even though the data DATA are applied to the odd numbered data electrodes X1, X2, . . . , Xm−1. Because of this, the cells of the even numbered horizontal line are selected by the discharge generated between the even numbered data electrodes X2, X4, . . . , Xm and the even numbered scan electrodes Y2, Y4, . . . , Yn.

In this way, after the address discharge being generated, positive wall charges are accumulated on the scan electrodes Y1 to Yn, and negative wall charges are accumulated on the data electrodes X1 to Xm.

On the other hand, during the period when the ramp-down waveform is applied and the address period, the common sustain electrode Z is supplied with a positive DC voltage Zdc.

During the sustain period, sustain pulses SUS are alternately applied to the scan electrodes Y1 to Yn and the common sustain electrodes Z. Whenever each sustain pulse SUS is applied, the cell selected by the address discharge has the wall charges within the cell added to the sustain pulse SUS to result the sustain discharge generated in a surface discharge type between the scan electrode Y and the common sustain electrode Z. At the end point of time of the sustain period, an erasure signal can be applied for eliminating the sustain discharge.

Referring to FIG. 11, in a driving method of a PDP according to the second embodiment of the present invention, two scan lines, i.e., rj^{th} (provided that rj represents odd numbers decreasing in order of n−1, n−3, . . . , 1) scan line SCRJ and (rj+1)^{th} scan line SCRJ+1, are scanned simultaneously. Also, in the driving method of the PDP according to the second embodiment of the present invention, scan is shifted in a reverse sequential direction where it proceeds from bottom to top.

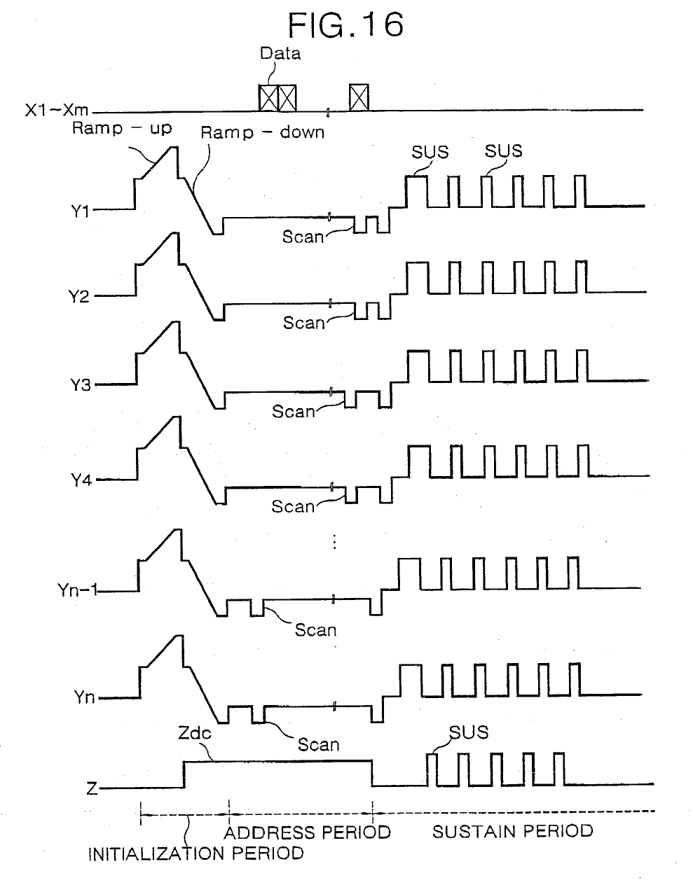

FIG. 16 illustrates a driving waveform for realizing a driving method shown in FIG. 11. In FIG. 16, an initialization period and a sustain period are substantially the same as that shown in FIG. 15, so a detailed description with respect thereto will be omitted.

Referring to FIG. 16, during the address period, a negative scan pulse SCAN is simultaneously applied to rj^{th} scan electrode Yrj and (rj+1)^{th} scan electrode Yrj+1. The scan pulse SCAN is shifted in a reverse sequential direction where it proceeds from bottom to top. In other words, after the scan pulse SCAN is simultaneously applied to (n−1)^{th} and n^{th} scan electrodes Yn−1 and Yn, the scan pulse is shifted in the reverse sequential direction, and then the scan pulse is simultaneously applied to first and second scan electrodes Y1 and Y2 lastly. The data electrode X1 to Xm are supplied with a data pulse DATA synchronized with the scan pulse SCAN. When a voltage difference between the scan pulse SCAN and the data pulse DATA is added to the wall voltage generated in the initialization period, an address discharge is generated within the cell supplied with the data pulse DATA. At this moment, the even numbered data electrodes X2, X4, . . . , Xm and the odd numbered data electrodes Y1, Y3, . . . , Yn−1 are overlapped having lattice barrier ribs 12 therebetween, so there is no discharge generated even though the data DATA are applied to the even numbered data electrodes X2, X4, . . . , Xm. Because of this, the cells of the odd numbered horizontal line are selected by the discharge generated between the odd numbered data electrodes X1, X3, . . . , Xm−1 and the odd numbered scan electrodes Y1, Y3, . . . , Yn−1.

On the contrary, the odd numbered data electrodes X1, X3, . . . , Xm−1 and the even numbered scan electrodes Y2, Y4, . . . , Yn are overlapped having lattice barrier ribs 12 therebetween, so there is no discharge generated even though the data DATA are applied to the odd numbered data electrodes X1, X2, . . . , Xm−1. Because of this, the cells of the even numbered horizontal line are selected by the discharge generated between the even numbered data electrodes X2, X4, . . . , Xm and the even numbered scan electrodes Y2, Y4, . . . , Yn.

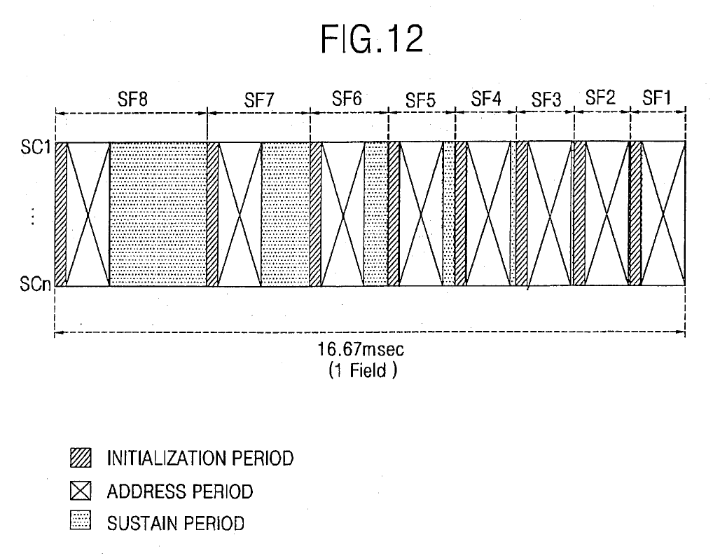

Referring to FIG. 12, in a driving method of the PDP according to the third embodiment of the present invention, two scan lines, i.e., fk^{th} (provided that fk represents odd numbers increasing in order of 1,3, . . . ,n−1) scan line SCFK and rk^{th} (provided that rk represents even numbers decreasing in order of n,n−2, . . . , 2) scan line SCRK, are scanned simultaneously. Also, in the driving method of the PDP according to the third embodiment of the present invention, scan is shifted in a reverse sequential direction where it proceeds from bottom to top, and at the same time in a forward sequential direction where it proceeds from top to bottom.

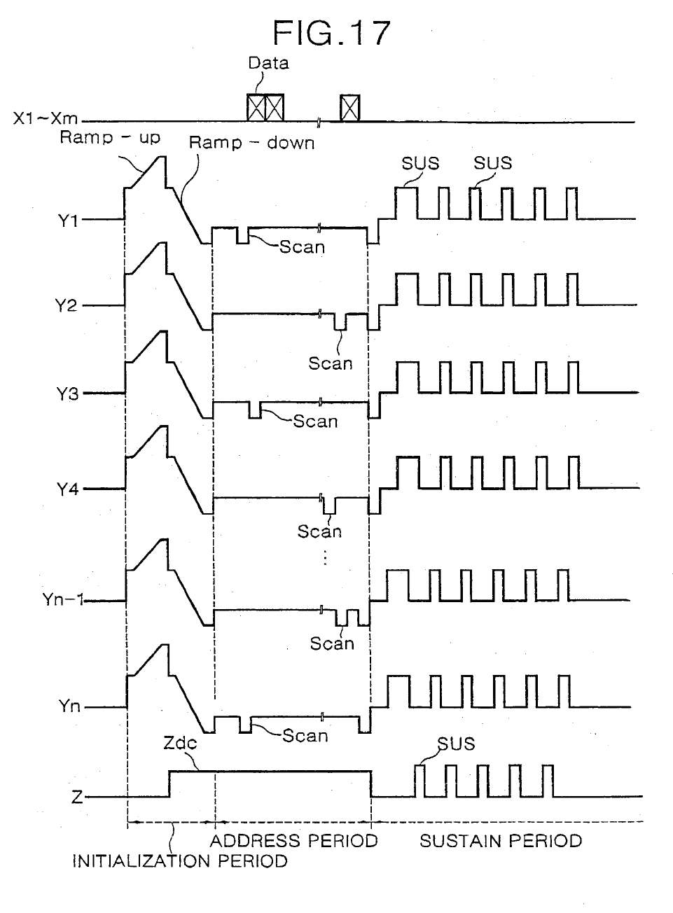

FIG. 17 illustrates a driving waveform for realizing a driving method shown in FIG. 12. In FIG. 17, a detailed description with respect to an initialization period and a sustain period will be omitted.

Referring to FIG. 17, during the address period, a negative scan pulse SCAN is simultaneously applied to fk^{th} scan electrode Yfk and rk^{th} scan electrode Yrk. The scan pulse SCAN is shifted in a forward sequential direction, and at the same time in a reverse sequential direction. In other words, after the scan pulse SCAN is simultaneously applied to first and n^{th} scan electrodes Y1 and Yn, the scan pulse Is shifted in the forward sequential direction and the reverse sequential direction, and then the scan pulse is simultaneously applied to the second and (n−1)^{th} scan electrodes Y2 and Y(n−1) lastly. The data electrodes X1 to Xm are supplied with a data pulse DATA synchronized with the scan pulse SCAN. When a voltage difference between the scan pulse SCAN and the data pulse DATA is added to the wall voltage generated in the initialization period, an address discharge is generated within the cell supplied with the data pulse DATA. At this moment, the even numbered data electrodes X2, X4, . . . , Xm and the odd numbered data electrodes Y1, Y3, . . . , Yn−1 are overlapped having lattice barrier ribs 12 therebetween, so there is no discharge generated even though the data DATA are applied to the even numbered data electrodes X2, X4, . . . , Xm. Because of this, the cells of the odd numbered horizontal line are selected by the discharge generated between the odd numbered data electrodes X1, X3, . . . , Xm−1 and the odd numbered scan electrodes Y1, Y3, . . . , Yn−1.

On the contrary, the odd numbered data electrodes X1, X3, . . . , Xm−1 and the even numbered scan electrodes Y2, Y4, . . . , Yn are overlapped having lattice barrier ribs 12 therebetween, so there is no discharge generated even though the data DATA are applied to the odd numbered data electrodes X1, X2, . . . , Xm−1. Because of this, the cells of the even numbered horizontal line are selected by the discharge generated between the even numbered data electrodes X2, X4, .., Xm and the even numbered scan electrodes Y2, Y4, . . . , Yn.

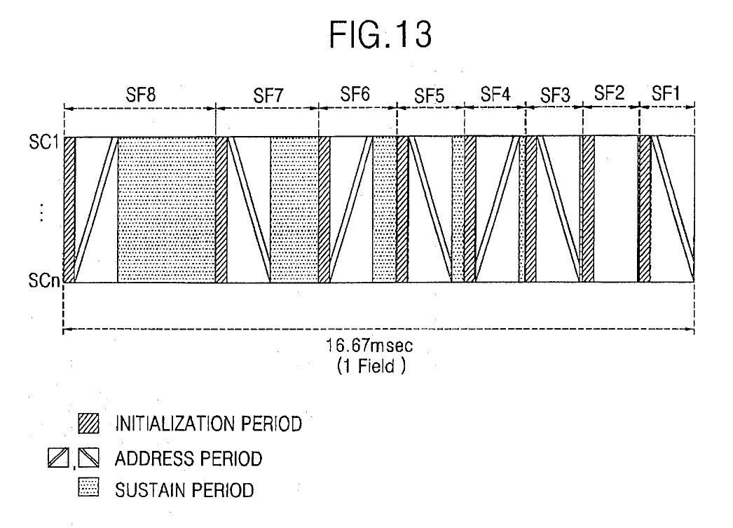

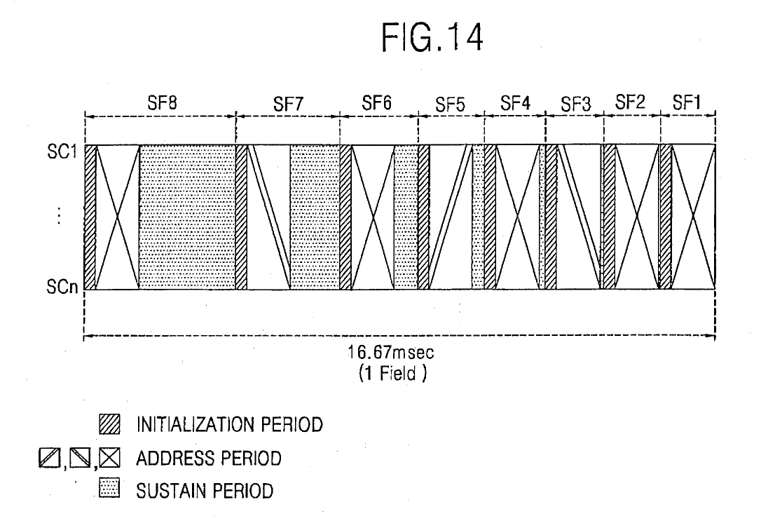

The dual scanning as in FIGS. 10, 11 and 12 can be mixed as in FIGS. 13 and 14.

Referring to FIG. 13, in a driving method of a PDP according to the fourth embodiment of the present invention, scan is shifted in a reverse sequential direction in odd numbered sub-fields SF1, SF3, . . . , SF7, and in a forward sequential direction in even numbered sub-fields SF2, SF4, . . . , SF8.

Referring to FIG. 14, in a driving method of a PDP according to the fifth embodiment of the present invention, scan is shifted in a reverse sequential direction in sub-fields SF1, SF2, SF4, SF6, SF8, and in a forward direction in sub-fields SF2, SF4, . . . , SF8.

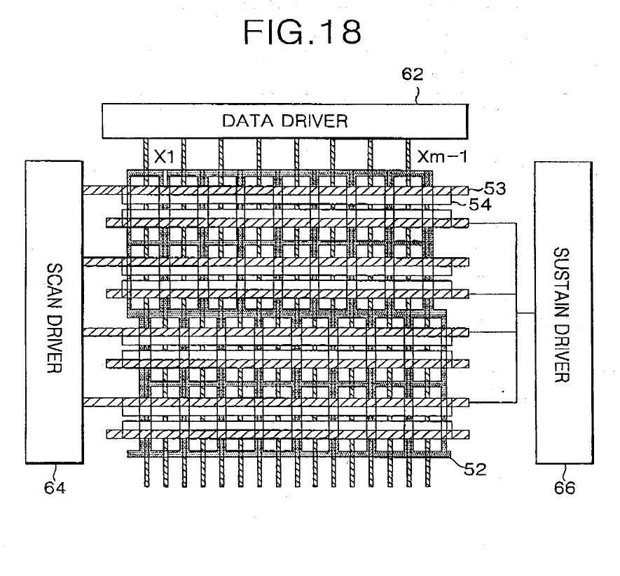

FIG. 18 illustrates a PDP and its driving apparatus according to another embodiment of the present invention.

Referring to FIG. 18, the PDP according to another embodiment of the present invention includes a lattice barrier ribs 52 arranged in a delta pattern to be deviated from adjacent cells by 1/2 cell pitch every second line in a longitudinal direction; odd numbered data electrodes X1, X3, . . . , Xm−1 exposed within a cell area of i^{th} (provided that i is a natural number) and (i+1)^{th} horizontal lines and overlapping under the lattice barrier ribs 52 in (i+2)^{th} and (i+3)^{th} horizontal lines; and even numbered data electrodes X2, X4, . . . , Xm overlapping under the lattice barrier ribs 52 in i^{th} and (i+1)^{th} horizontal lines and exposed within a cell area of (i+2)^{th} and (i+3)^{th} horizontal lines.

There are n number of scan electrodes Y1 to Yn and n number of common sustain electrodes Z formed on an upper glass substrate (not shown), and intersecting m number of data electrodes X1 to Xm formed on a lower glass substrate (not shown) with a discharge space therebetween.

The scan electrodes Y1 to Yn and the common sustain electrode Z each include a transparent electrode 54 of indium-tin-oxide ITO and a metal bus electrode 53 that is formed on the transparent electrode 54 for reducing a voltage drop caused by the transparent electrode 54.

On the upper glass substrate, a dielectric layer and an MgO passivation film (not shown) are deposited to cover the scan electrodes Y1 to Yn and the common sustain electrode Z.

There is a dielectric thick film formed on a lower glass substrate that faces the upper glass substrate with a discharge space therebetween, the dielectric thick film covering data electrodes X1 to Xm. On top of that, the lattice barrier ribs 52 are formed. On the surface of the dielectric thick film and the lattice barrier ribs 52, there is a fluorescent body formed. And, after an upper plate and a lower plate thereof are bonded together, subsequently to the exhaust, there are inert gas mixture such as He+Xe, Ne+Xe, He+Xe+Ne etc. interposed into the discharge space provided between the upper plate, the lower plate and the barrier ribs 52.

Also, the driving apparatus of the PDP according to the present invention includes a data driver 62 for applying video data to the data electrodes X1 to Xm, a scan driver 64 for applying a scan signal and a sustain pulse to the scan electrodes Y1 to Yn, and a sustain driver 66 for applying a sustain pulse to the common sustain electrode Z.

The data driver 62 applies the data for selecting cells of the odd numbered horizontal line to the odd numbered data electrodes X1, X3, . . . , Xm−1, and at the same time, the data for selecting cells of the even numbered horizontal line to the even numbered data electrodes X2, X4, . . . , Xm. The data driver 62 can be installed on the upper side or the lower side of the panel.

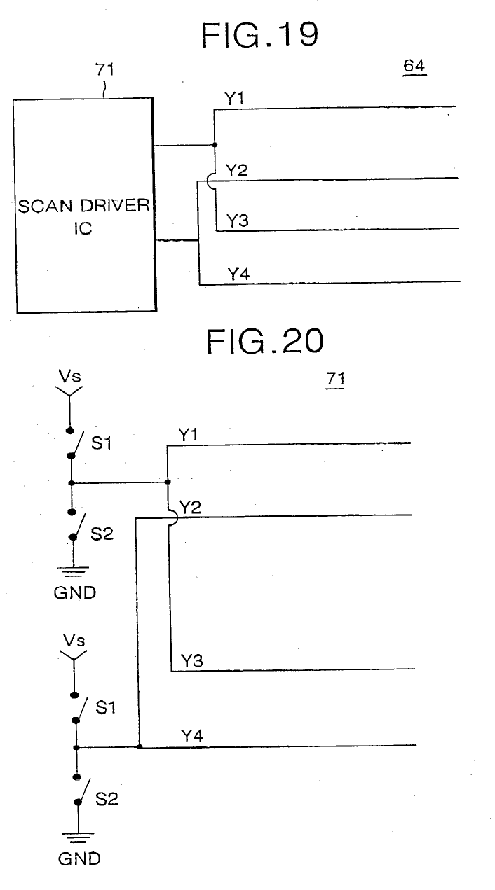

The scanning driver 64 applies the scan pulse to two scan electrodes simultaneously and shifts the scan pulse from top to bottom or from bottom to top with respect to n number of the scan electrodes Y1 to Yn. Also, the scan driver 64 selects the scan line, then applies the sustain pulse to the n number of scan electrodes Y1 to Yn. Each of a plurality of driver integrated circuit IC's 71 included in the scan driver 64 have it output terminal connected in parallel with two scan electrodes as in FIG. 19 and 20 in order to select two scan lines with one scan pulse. Herein, as in FIGS. 19 and 20, i^{th} scan electrode Yi and (i+2)^{th} scan electrode Yi+2 are commonly connected, and (i+1) th scan electrode Yi+1 and (i+3)^{th} scan electrode Yi+3 are commonly connected. Accordingly, upon dual scanning there is selected either two of the odd numbered scan electrode Yi and Yi+2 or two of the even numbered scan electrode Yi+1 and Yi+3.

The sustain driver 66 and the scan driver 64 alternately applies the sustain pulse to the common sustain electrode z.

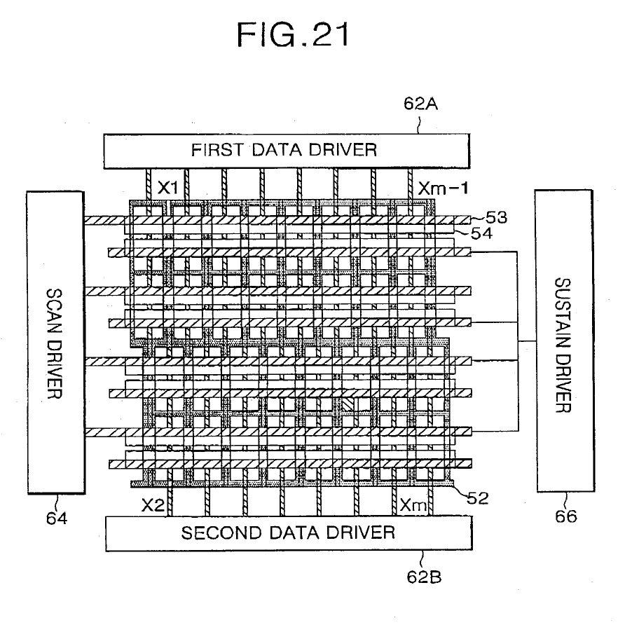

On the other hand, the data driver 62, as in FIG. 21, can be divided into a first data driver 62A driving the odd numbered data electrode X1, X3, . . . , Xm−1 and a second data driver 62B driving the even numbered data electrode X2, X4, . . . , Xm. The first data driver 62A is installed at an upper end of the panel and connected to the odd numbered data electrodes X1, X3, . . . . , Xm−1, thereby applying odd numbered data to the odd numbered data electrodes X1, X3, . . . , Xm−1 simultaneously. The second data driver 62B is installed at a lower end of the panel and connected to the even numbered data electrodes X2, X4, . . . , Xm, thereby applying even numbered data to the even numbered data electrodes X2, X4, . . . , Xm simultaneously.

As a result, the driving method and apparatus according to the present invention selects two or more scan lines for each scan pulse, thereby reducing the address period.

For example, the driving method and apparatus according to the present invention is capable of scanning the whole line with half as much time as needed in the prior art, so an address period needed in one sub-field in a resolution of VGA class is reduced to be 3 μs×240=0.72 ms assuming that a pulse width of the scan pulse is 3 μs. Accordingly, in the driving method and apparatus according to the present invention, the initialization period needed in one sub-field is around 300˜600 μs, and assuming that 8 sub-fields SF1 to SF8 are included within one frame period 16.67 ms, the total initialization period and address period needed within one frame period in a resolution of VGA class is no more than (0.72 ms×8)+((0.3˜0.6 ms)×8)=8.16˜10.56 ms. As a result, the sustain period in the resolution of VGA class is 16.67 ms (frame period)−(8.16˜10.56 ms)=6.11˜8.15 ms, such that it is possible to assure triple or more period as compared with the prior art.

If the resolution is increased to be of XGA (1024×768) class, an address period is 3 μs×384=1.15 ms. Accordingly, in the driving method and apparatus according to the present invention, assuming that the initialization period needed in one sub-field is around 300˜600 μs and that 8 sub-fields SF1 to SF8 are included, the total initialization period and address period within one frame period in the resolution of XGA class is no more than (1.15 ms×8)+((0.3˜0.6 ms)×8)=11.6˜14.0 ms. As a result, the sustain period in the resolution of XGA class can be assured as 16.67 ms (frame period)−(11.6˜14.0 ms)=2.67˜5.07 ms.

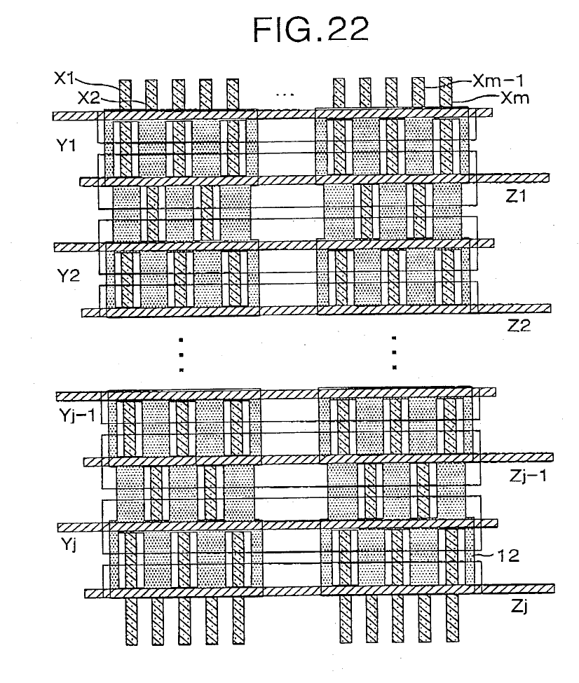

The dual scanning method described in the foregoing embodiments can be applicable to a PDP, as in FIG. 22, in which metal electrodes of the scan electrodes Y1 to Yj and the sustain electrodes Z1 to Zj overlap with the barrier ribs 12. In this case, during the address period, the scan electrodes Y1 to Yj and the sustain electrodes Z1 to Zj are supplied with the scan pulses and shared by two horizontal display lines respectively. Because of this, the number of scan electrodes Y1 to Yj and sustain electrodes Z1 to Zj is decreased to about 1/2 or less than that of the PDP shown in FIGS. 4, 9, 18 and 21.

As described above, the method and apparatus of driving the present invention is capable of reducing the address period, as compared with the prior art, by scanning at least two or more scan lines with one scan pulse at the same time. Accordingly, the method and apparatus of driving the present invention can assure the sustain period even in the event that the number of cells increase as the PDP is of high resolution, so that it can realize the high resolution and increase its brightness by increasing the sustain discharge frequency as much as the sustain period is assured. Furthermore, the method and apparatus of driving the PDP according to the present invention is capable of assuring enough sustain period even in the event that the number of sub-fields is increased for reducing a moving picture pseudo contour noise.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A method of driving a plasma display panel, the plasma display panel has scan electrodes intersect data electrodes that overlap with barrier ribs periodically, wherein a scan pulse is simultaneously applied to at least two or more of the scan electrodes.

2. The method according to claim 1, wherein the scan pulses are applied to the plasma display panel, beginning from the top thereof, and then are shifted downward.

3. The method according to claim 1, wherein the scan pulses are applied to the plasma display panel, beginning from the bottom thereof, and then are shifted upward.

4. The method according to claim 1, wherein the scan pulses are applied to the plasma display panel, beginning from the top thereof, and then are shifted downward, and at the same time beginning from the bottom thereof, and then is shifted upward.

5. The method according to claim 1, wherein there are at least two or more sub-fields in which scan directions of the scan pulses are different from each other when shifted.

6. The method according to claim 1, further comprising a step of:
dividing data pulses synchronized with the scan pulses into odd-numbered lines and even-numbered lines and applying the data pulse to the data lines.

7. A driving apparatus of a plasma display panel, comprising:
a plasma display panel having scan electrodes intersect data electrodes that are located under barrier ribs periodically; and
a scan driver simultaneously applying a scan pulse to at least two or more of the scan electrodes.

8. The driving apparatus according to claim 7, wherein the scan driver applies the scan pulses to the plasma display panel, beginning from the top thereof, and then are shifted downward.

9. The driving apparatus according to claim 7, wherein the scan driver applies the scan pulses to the plasma display panel, beginning from the bottom thereof, and then are shifted upward.

10. The driving apparatus according to claim 7, wherein the scan driver applies the scan pulses to the plasma display panel, beginning from the top thereof, and then are shifted downward, and at the same time beginning from the bottom thereof, and then is shifted upward.

11. The driving apparatus according to claim 7, wherein the scan driver makes scan directions of the shifted scan pulses different in sub-fields that are different from one another.

12. The driving apparatus according to claim 7, further including:
a data driver dividing data pulses synchronized with the scan pulses into odd-numbered lines and even-numbered lines and applying the data pulse to the data lines.

13. The driving apparatus according to claim 7, wherein the scan driver includes:
a switching device connected in parallel with at least two or more of the scan electrodes and applying the scan pulse to at least two or more of the scan electrodes at the same time.

14. The driving apparatus according to claim 7, wherein the barrier ribs are a lattice type and are arranged in a delta pattern to be deviated from adjacent cells in a vertical direction.

15. The driving apparatus according to claim 14, wherein the data electrodes include:
odd-numbered data electrodes exposed within the cell area of odd-numbered horizontal lines and located under the barrier ribs in even-numbered horizontal lines; and
even-numbered data electrodes exposed within the cell area of even-numbered horizontal lines and located under the barrier ribs in odd-numbered horizontal lines.

16. The driving apparatus according to claim 7, wherein the barrier ribs are a lattice type and are arranged in a delta pattern to be deviated from adjacent cells in a vertical direction every second line.

17. The driving apparatus according to claim 16, wherein the data electrodes include:
odd-numbered data electrodes exposed within the cell area of i^{th} (provided that i is a natural number) and (i+1)^{th} horizontal lines, and located under the barrier ribs in (i+2)^{th} and (i+3)^{th} horizontal lines; and
even-numbered data electrodes located under the barrier ribs in i^{th} and (i+1)^{th} horizontal lines, and exposed within the cell area of (i+2)^{th} and (i+3)^{th} horizontal lines.

18. The driving apparatus according to claim 7, further including:
a sustain electrode generating a sustain discharge, together with the scan electrode.

19. The driving apparatus according to claim 14, wherein the scan electrode and the sustain electrode each include a metal bus electrode.

20. The driving apparatus according to claim 19, wherein the lattice type barrier ribs include transversal barrier ribs and longitudinal barrier ribs, and the metal bus electrode overlaps with the transversal barrier ribs.
